(19) United States
(12) Patent Application Publication
(10) Pub. No.: US 2021/0129849 A1
(43) Pub. Date: May 6, 2021

(54) ROAD TOPOLOGY ESTIMATION USING LANE IDENTIFIERS

(71) Applicant: Jeremy A. Whitehead, Pontiac, MI (US)

(72) Inventor: Jeremy A. Whitehead, Pontiac, MI (US)

(21) Appl. No.: 16/670,561

(22) Filed: Oct. 31, 2019

(51) Int. Cl. B60W 40/06; G06K 9/00; G05D 1/00; G05D 1/02

(52) U.S. Cl. CPC B60W 40/06; G06K 9/00798; B60W 2710/10; G05D 1/0246; B60W 2420/42; G05D 1/0088

(57) ABSTRACT

A controller of a vehicle obtains lane identifier information indicative of identifiers that define a lane of a road along which the vehicle will travel, determines distances between the lane identifiers at a plurality of different points along the lane based on the lane identifier information to obtain lane width information, determines a depth or distance from the vehicle to each of the plurality of different points along the lane using the lane width information and a known or assumed lane width to obtain an uncorrected lane topology profile, transforms the uncorrected lane topology profile to an inertial frame of reference of the vehicle based on a monitored orientation of the vehicle by a set of sensors to obtain a corrected lane topology profile, and controls an autonomous driving feature of the vehicle based on the corrected lane topology profile to proactively compensate for an upcoming road topology variation.

### FIELD

The present application generally relates to vehicle autonomous driving systems and, more particularly, to road topology estimation using lane identifiers.

### BACKGROUND

Some autonomous driving systems are configured to perform adaptive or intelligent cruise control, which involves the vehicle maintaining a desired speed while also maintaining a safe distance from other objects (e.g., another vehicle in front of itself). The cruise control process typically involves the vehicle controlling its acceleration and deceleration based on a speed difference or error between a cruise control speed set point and the actual speed of the vehicle. This feedback-based solution is reactive to the scenario and hence is prone to delays, particularly on roads having a hilly topology, which could be undesirable to a driver of the vehicle. For example, when the road transitions from a flat grade to a steep incline, there could be a delay in the vehicle accelerating until its monitored speed error substantially increases. In addition, unnecessary gear shifts of a transmission could be performed prior to a road topology change, which could also be undesirable to the driver. Accordingly, while such autonomous driving systems do work well for their intended purpose, there exists an opportunity for improvement in the relevant art.

### SUMMARY

According to one example aspect of the invention, a road topology estimation and autonomous driving system for a vehicle is presented. In one exemplary implementation, the system comprises: a set of sensors configured to monitor an orientation of the vehicle and a controller configured to: obtain lane identifier information indicative of identifiers that define a lane of a road along which the vehicle will travel, based on the lane identifier information, determine distances between the lane identifiers at a plurality of different points along the lane to obtain lane width information, using the lane width information and a known or assumed lane width, determine a depth or distance from the vehicle to each of the plurality of different points along the lane to obtain an uncorrected lane topology profile, based on the monitored orientation of the vehicle, transform the uncorrected lane topology profile to an inertial frame of reference of the vehicle to obtain a corrected lane topology profile, and control an autonomous driving feature of the vehicle based on the corrected lane topology profile to proactively compensate for an upcoming road topology variation.

In some implementations, the lane identifier information is obtained from a two-dimensional (2D) image captured by a front-facing camera of the vehicle. In some implementations, the lane identifier information includes a plurality of x-y coordinate pairs representing pixels of the 2D image that correspond to the lane identifiers. In some implementations, the controller is configured to determine the distances between the lane identifiers at the plurality of different points along the lane by determining an x-coordinate difference at a plurality of different y-coordinates of the plurality of x-y coordinate pairs. In some implementations, the controller is configured to transform the uncorrected lane topology profile from a frame of reference of the front-facing camera to the inertial frame of reference of the vehicle. In some implementations, the monitored orientation of the vehicle comprises at least one of yaw, pitch, and roll of at least one of the front-facing camera and the vehicle.

In some implementations, the controller receives the image from the front-facing camera and identifies the lane identifier information from the image. In some implementations, the front-facing camera identifies and provides to the controller the lane identifier information as two polynomials or datasets defining the lane identifiers. In some implementations, the autonomous driving feature is adaptive or intelligent cruise control, and wherein the controller utilizes the corrected lane topology profile to proactively control acceleration or deceleration of the vehicle during adaptive or intelligent cruise control operation in anticipation of the upcoming road topology variation. In some implementations, the autonomous driving feature is transmission gear shift management, and wherein the controller utilizes the corrected lane topology profile to proactively control gear shifts of a transmission of the vehicle in anticipation of the upcoming road topology variation.

According to another example aspect of the invention, a road topology estimation and autonomous driving method for a vehicle is presented. In one exemplary implementation, the method comprises: receiving, by a controller of the vehicle and from a set of sensors of the vehicle, a monitored orientation of the vehicle, obtaining, by the controller, lane identifier information indicative of identifiers that define a lane of a road along which the vehicle will travel, based on the lane identifier information, determining, by the controller, distances between the lane identifiers at a plurality of different points along the lane to obtain lane width information, using the lane width information and a known or assumed lane width, determining, by the controller, a depth or distance from the vehicle to each of the plurality of different points along the lane to obtain an uncorrected lane topology profile, based on the monitored orientation of the vehicle, transforming, by the controller, the uncorrected lane topology profile to an inertial frame of reference of the vehicle to obtain a corrected lane topology profile, and controlling, by the controller, an autonomous driving feature of the vehicle based on the corrected lane topology profile to proactively compensate for an upcoming road topology variation.

In some implementations, the lane identifier information is obtained from a 2D image captured by a front-facing camera of the vehicle. In some implementations, the lane identifier information includes a plurality of x-y coordinate pairs representing pixels of the 2D image that correspond to the lane identifiers. In some implementations, the determining of the distances between the lane identifiers at the plurality of different points along the lane comprises determining an x-coordinate difference at a plurality of different y-coordinates of the plurality of x-y coordinate pairs. In some implementations, the transforming of the uncorrected lane topology profile is from a frame of reference of the front-facing camera to the inertial frame of reference of the vehicle. In some implementations, the monitored orientation of the vehicle comprises at least one of yaw, pitch, and roll of at least one of the front-facing camera and the vehicle.

In some implementations, the method further comprises receiving, by the controller and from the front-facing camera, the image, and identifying, by the controller, the lane identifier information from the image. In some implementations, the front-facing camera identifies and provides to the controller the lane identifier information as two polynomials or datasets defining the lane identifiers. In some implementations, the autonomous driving feature is adaptive or intelligent cruise control, and wherein controlling the autonomous driving feature comprises utilizing the corrected lane topology profile to proactively control acceleration or deceleration of the vehicle during adaptive or intelligent cruise control operation in anticipation of the upcoming road topology variation. In some implementations, the autonomous driving feature is transmission gear shift management, and wherein controlling the autonomous driving feature comprising utilizing the corrected lane topology profile to proactively control gear shifts of a transmission of the vehicle in anticipation of the upcoming road topology variation.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of a vehicle having an example autonomous driving system according to the principles of the present disclosure;

FIGS. 2A-2F are views of example roads having different topologies and types of lane identifiers and corresponding lane identifier information according to the principles of the present disclosure;

FIG. 3 is a functional block diagram of an example road topology estimation and autonomous driving architecture according to the principles of the present disclosure;

FIGS. 4A-4B are diagrams of example width extraction and depth inference techniques according to the principles of the present disclosure; and

FIG. 5 is a flow diagram of an example road topology estimation and autonomous driving method according to the principles of the present disclosure.

### DETAILED DESCRIPTION

As previously discussed, one feature possible for an autonomous driving system of a vehicle is adaptive or intelligent cruise control, which involves a vehicle maintaining a desired speed while also maintaining a safe distance from other objects (e.g., another vehicle in front of itself). It will be appreciated that the term “autonomous” as used herein refers to both fully-autonomous driving features and semi-autonomous driving (also known as “driver-assistance”) features where at least some driver attention or interaction needs to be maintained. The conventional cruise control process involves the vehicle controlling its acceleration and deceleration based on a speed difference or error between a cruise control speed set point and an actual speed of the vehicle. This conventional feedback-based solution is reactive to the scenario and hence is prone to delays, particularly on roads having a hilly topology, which could be undesirable to a driver of the vehicle. In addition, these conventional autonomous driving systems could perform unnecessary gear shifts of a transmission prior to a road topology change, which could also be undesirable to the driver.

Accordingly, improved autonomous driving systems and methods are presented that leverage an estimated road topology profile to proactively control vehicle speed (acceleration or deceleration) and/or proactively control gear shifts of the transmission. Potential benefits include more accurate vehicle speed control and mitigating or preventing unnecessary transmission gear shifts, thereby improving the driver's experience. While these two autonomous driving features are specifically discussed herein, it will be appreciated that the estimated road topology profile could be utilized as part of any suitable autonomous driving or driver-assistance features dealing with longitudinal control of the vehicle.

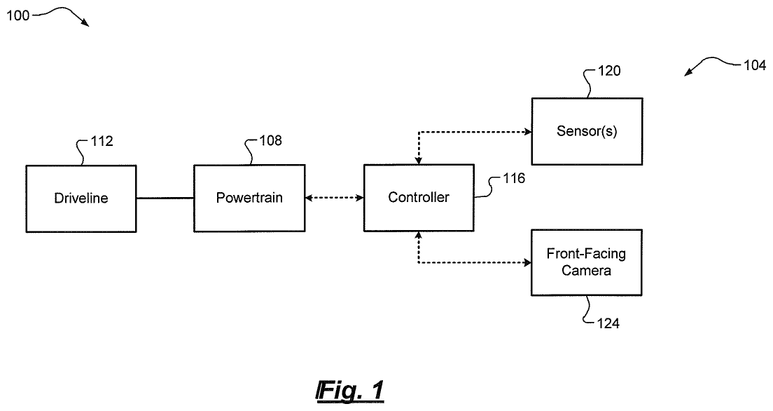

Referring now to FIG. 1, a functional block diagram of a vehicle 100 having an autonomous driving system 104 according to the principles of the present disclosure is illustrated. The vehicle 100 comprises a powertrain 104 (e.g., an engine, an electric motor, or some combination thereof) that generates drive torque and transfers the drive torque via a transmission (not shown) of the powertrain 104 to a driveline 112 to propel the vehicle 100. A controller 116 controls operation of the vehicle 100, including controlling the powertrain 108 to generate a desired amount of drive torque. The controller 116 receives information or measurements from a set of sensors 120 configured to monitor an orientation of the vehicle 100. The controller 116 also receives two-dimensional (2D) images captured by a front-facing camera 124 of the vehicle 100. These captured images are of a scene in front of the vehicle 100. The autonomous driving system 104 of the present disclosure comprises the controller 116, the set of sensors 120, and, optionally, the front-facing camera 124.

In one exemplary embodiment, the front-facing camera 124 is an intelligent camera that is configured to detect lane identifiers from captured raw images and output lane identifier information to the controller 116 or the front-facing camera 124 is otherwise integrated as part of the controller 116. In another exemplary implementation, the front-facing camera 124 is separate from the controller 116 and only provides the captured raw images to the controller 116, and the controller 116 then analyzes the captured raw images to detect lane identifiers and generate lane identifier information. While the use of 2D front-facing images captured by the front-facing camera 124 is specifically described herein, it will be appreciated that the lane identifier information could be obtained using other sensor systems (e.g., a light detection and ranging, or LIDAR system). It will also be appreciated that the set of sensors 120 could include any other suitable vehicle sensors, such as powertrain speed and vehicle speed sensors for use by the autonomous driving system 104.

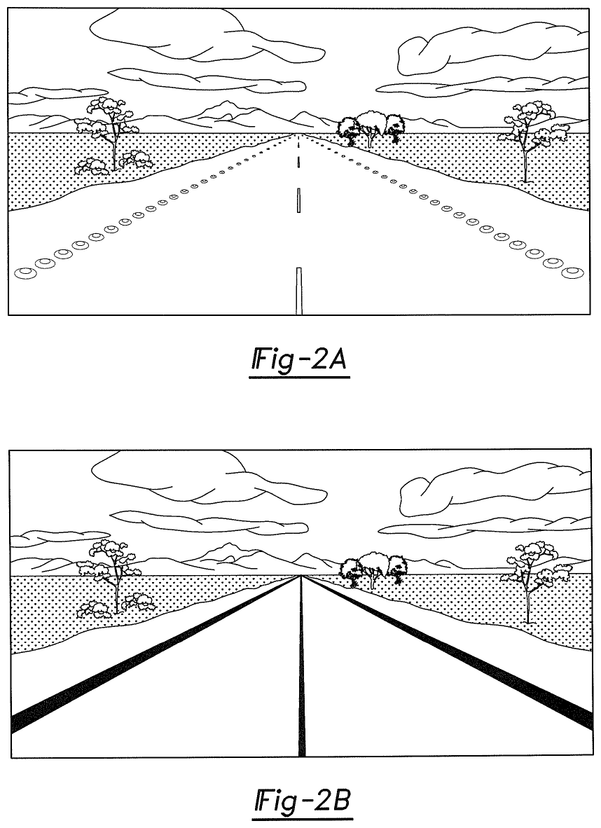

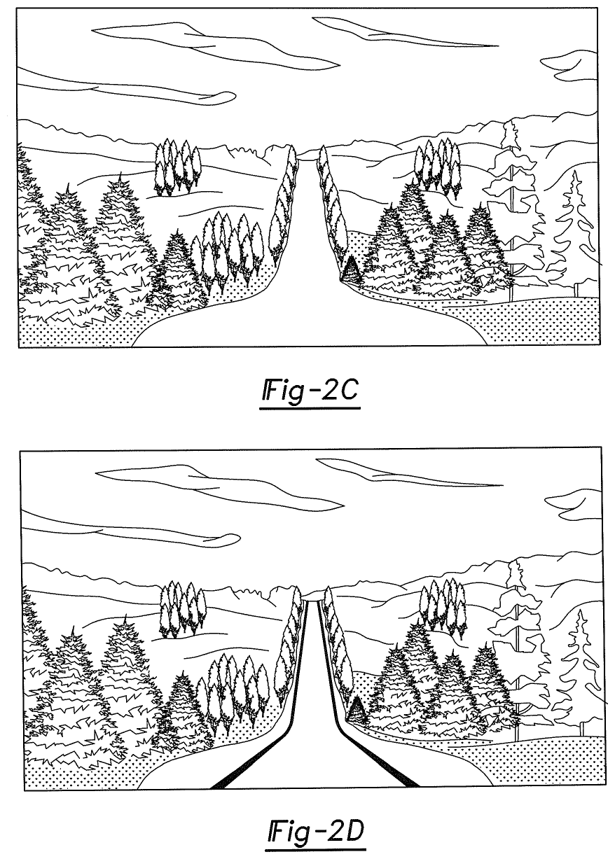

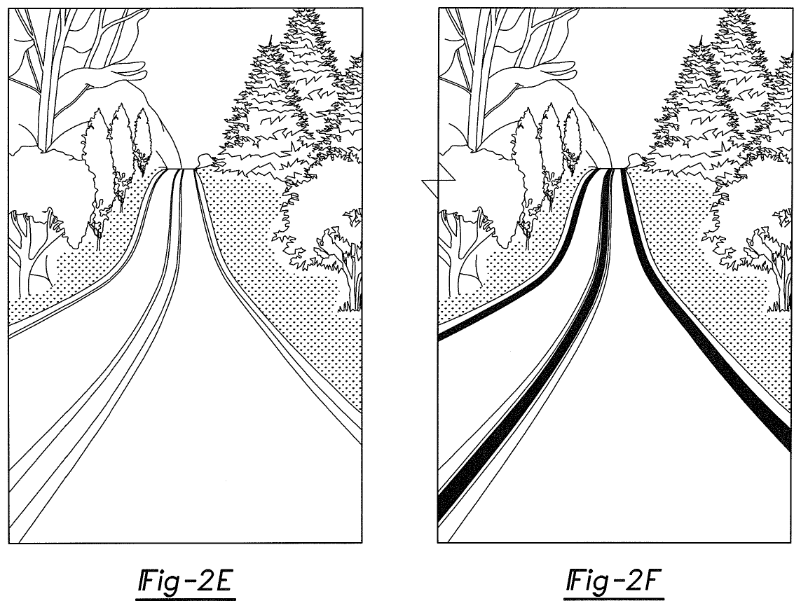

Referring now to FIGS. 2A-2F, example views roads having different topologies and different lane identifiers and corresponding lane identifier information according to the principles of the present disclosure are illustrated. It will be appreciated that these images and the corresponding lane identifiers are merely examples and that the techniques of the present disclosure are applicable to any types of roads and any types of lane identifiers. FIGS. 2A-2B illustrate a flat road, FIGS. 2C-2D illustrate a downhill to uphill road, and FIGS. 2E-2F illustrate a flat to uphill road. It will be appreciated that these example views could be 2D images captured by the front-facing camera 124 of the vehicle 100 or another suitable camera system associated with the vehicle 100. In FIG. 2A, a flat road is shown having a dashed inner lane identifier and dotted (e.g., raised or textured “botts dots”) for outer lane identifiers. In FIG. 2B, lane identifier information is obtained, which is indicative of the boundaries of the road and its lanes. As shown, the dashed inner lane identifier and the dotted outer lane identifiers are identified as thick lane lines, which are also referred to herein as lane identifier information. For a flat road, such as the one illustrated in FIGS. 2A-2B, the lane identifier information has a triangular shape with linear lines.

In FIGS. 2C-2D, on the other hand, a downhill then uphill road topology is illustrated. As can be seen in FIG. 2C, there are no actual lane identifiers. Instead, as shown in FIG. 2D, edges of the road are detectable and lane identifier information is obtained, which could be at the actual edges of the road or could be slightly offset from the edges (e.g., by a predetermined amount). As shown in FIG. 2D, the lane identifier information is non-linear and thus the illustrated thick lane lines could also be described as “polynomials.” Instead of polynomials, the lane lines (including non-linear lane lines) could be represented by datasets. In one exemplary implementation, the lane identifier information includes a set of pixels (e.g., in an x-y coordinate space of the image) where the lane identifiers are detected. Similarly, FIGS. 2E-2F illustrate a flat to uphill road topology. As shown in FIG. 2E, there is a double solid center lane line identifier and two solid outer lane identifiers. In FIG. 2F, the lane identifier information is obtained with thick lane lines where the solid outer lane identifiers are and with a central thick lane line in between the double solid center lane line identifier. Similar to FIGS. 2C-2D, this lane identifier information is non-linear and thus could also be described as polynomials. As previously discussed herein, this lane identifier information (or polynomials) could be identified and output by the front-facing camera 124 itself or, alternatively, could be performed by the controller 116.

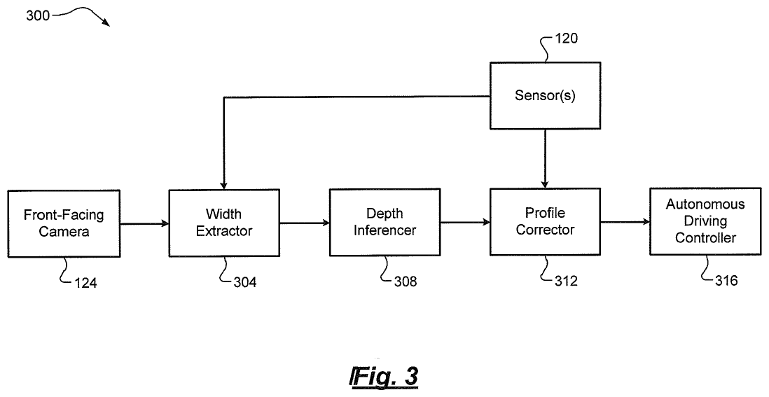

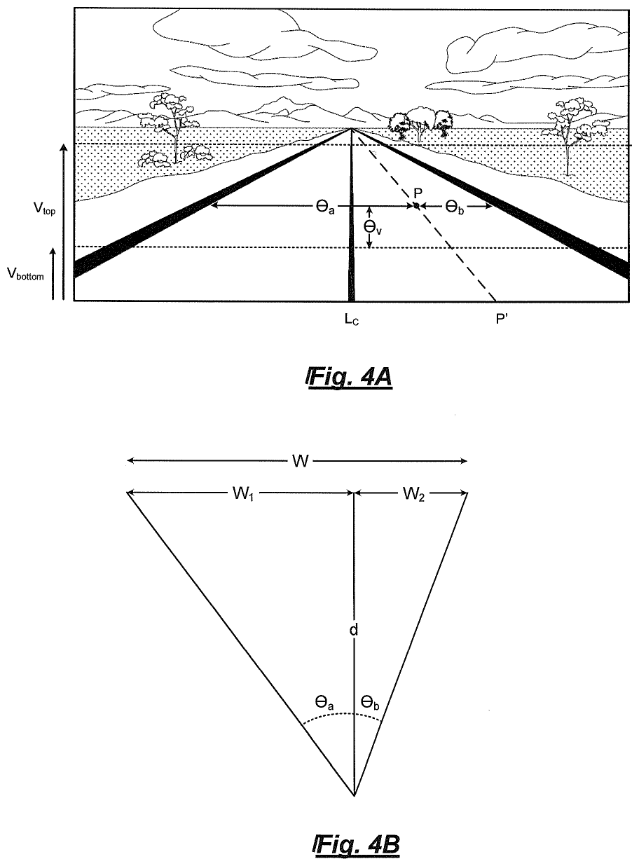

Referring now to FIG. 3 and with additional reference to FIGS. 4A-4B, a functional block diagram of an example road topology estimation and autonomous driving architecture 300 according to the principles of the present disclosure is illustrated. A width extractor 304 extracts lane width information (e.g., for a plurality of different points along the lane) from the lane identifier information, taking into account a relative position of the vehicle 100 with respect to the lane(s) of the road. The lane width information is then provided to a depth inferencer 308 that infers the depth or distance from the vehicle 100 to each of the plurality of different points along the lane using the lane width information and a known or assumed lane width to obtain an uncorrected lane topology profile. The uncorrected lane topology profile is then provided to a profile corrector 312 that, based on the monitored orientation of the vehicle 100 from the set of sensors 120, transforms the uncorrected lane topology profile to an inertial frame of reference, either centered on the vehicle 100 or anywhere else in Cartesian space, to obtain a corrected lane topology profile. This corrected lane topology profile could then be provided to an autonomous driving controller 316, which could utilize the corrected lane topology profile for improved control of one or more autonomous driving features.

FIG. 4A illustrates a diagram of an example technique for lane width extraction according to the principles of the present disclosure and using the image from FIG. 2B. In this example technique, the width of the lane at different distances and elevations within the image is extracted. This extraction could be limited, for example, to a subset of the image height (Vₜₒₚ-V_{bottom}) to reduce processing complexity, such as for cases of resolution constraints. As shown, there is a virtual center or dividing lane line (Lc) placed in the immediate center between the outer lane lines. The purpose of this virtual center lane line L_{c} is to distinguish the difference between the center of the two outer lane lines and the actual path of the vehicle in that lane (P′). The techniques described herein are robust to this offset due to the width extraction process. At some vertical level in the image (⊖ᵥ), image pixels are counted horizontally from a horizontal location along P′ (e.g., from a point P), which represents a center of the vehicle with reference to the lane to either of the lane/road marking boundaries or extremes. This is then related to the angular position of the lane marking with reference to the camera (⊖ₐ, ⊖_{b}). In some implementations, these values could be slightly corrected if there is a known roll or other orientation error in the camera's position/orientation in addition to any other corrections not necessary to compensate for distortions in the camera lens. These pixel counts or calculations are then repeated for other vertical levels within the vertical range to create sets (⊖ₐₙ, ⊖_{bn}), where n represents the varying vertical levels. These sets are also referred to herein as lane width information.

FIG. 4B illustrates a diagram of an example technique for depth inference according to the principles of the present disclosure. Using the lane width information determined above and assuming a known lane width (W), a depth can be inferred or calculated. For each vertical level n, the angular positions ⊖ₐ, ⊖_{b}, first and second width portions (W₁, W₂) of the full width W are as follows: W₁=d*tan(⊖ₐ) and W₂=d*tan(⊖_{b}). Based on this assumed width W and using the angular positions ⊖ₐ, ⊖_{b}, the depth (d) at each vertical position n is calculated or inferred as follows: d=W/[tan(⊖a)+tan(⊖b)]. A set of the inferred or calculated depths (dₙ) at all of the various vertical levels n is also referred to herein as an uncorrected lane or road topology profile. This is described as uncorrected because it does not account for orientation differences (yaw, pitch, roll, etc.) between the front-facing camera 124 and the vehicle 100. In other words, the topology profile is currently in the camera's frame of reference and not the vehicle's inertial frame of reference. Thus, based on the monitored orientation parameters from sensor(s) 120, the uncorrected lane or road topology profile is transformed to the inertial reference frame of the vehicle 100 to obtain what is also referred to herein as a corrected lane or road topology profile, which is then utilizable for autonomous driving feature(s).

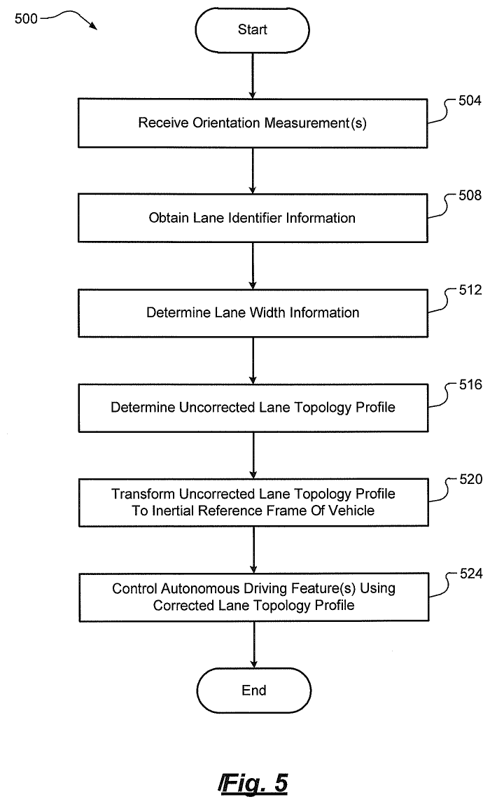

Referring now to FIG. 5, a flow diagram of an example road topology estimation and autonomous driving method 500 according to the principles of the present disclosure is illustrated. While being described as being implemented by the controller 116, it will be appreciated that the method 500 could be implemented by any suitable vehicle controller or control system. At 504, the controller 116 receives, from the set of sensors 120, a monitored orientation of the vehicle 100. As previously discussed, this could include some combination of yaw, pitch, and roll of the vehicle 100 and/or the front-facing camera 124. At 508, the controller 116 obtains lane identifier information indicative of identifiers that define a lane of a road along which the vehicle 100 will travel. As previously discussed, the generation of this lane identifier information could be performed by the front-facing camera 124 itself (e.g., generation and output of two polynomials) or could be performed by the controller 116 using any suitable methods. At 512, the controller 116 determines distances between the lane identifiers at a plurality of different points along the lane based on the lane identifier information to obtain lane width information. At 516, the controller 116 uses the lane width information and a known or assumed lane width to determine a depth or distance from the vehicle 100 to each of the plurality of different points along the lane to obtain an uncorrected lane topology profile.

At 520, the controller 116 uses the monitored orientation of the vehicle 100 to transform the uncorrected lane topology profile to an inertial frame of reference of the vehicle 100 to obtain a corrected lane topology profile. This could include, for example only, adjusting the uncorrected lane topology to account for a mounting orientation of the front-facing camera 124 relative to the orientation of the vehicle 100. Finally, at 524, the controller 116 controls an autonomous driving feature of the vehicle 100 based on the corrected lane topology profile. As previously discussed, this feature could be adaptive or intelligent cruise control, transmission gear shift management, or any other suitable autonomous driving feature. In one exemplary implementation, the corrected lane topology profile could be used to proactively accelerate or decelerate the vehicle 100 during adaptive or intelligent cruise control in anticipation of an upcoming road topology variation. For example, the vehicle 100 could begin accelerating as an uphill topology approaches. In another exemplary implementation, the corrected lane topology profile could be used to proactively shift gears of the transmission in anticipation of an upcoming road topology variation. For example, an upshift of the transmission that would normally be performed could be prevented or the transmission could be downshifted as an uphill topology approaches. The method 500 then ends or returns to 504 for one or more additional cycles.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A road topology estimation and autonomous driving system for a vehicle, the system comprising:
a set of sensors configured to monitor an orientation of the vehicle; and
a controller configured to:
obtain lane identifier information indicative of identifiers that define a lane of a road along which the vehicle will travel;
based on the lane identifier information, determine distances between the lane identifiers at a plurality of different points along the lane to obtain lane width information;
using the lane width information and a known or assumed lane width, determine a depth or distance from the vehicle to each of the plurality of different points along the lane to obtain an uncorrected lane topology profile;
based on the monitored orientation of the vehicle, transform the uncorrected lane topology profile to an inertial frame of reference of the vehicle to obtain a corrected lane topology profile; and
control an autonomous driving feature of the vehicle based on the corrected lane topology profile to proactively compensate for an upcoming road topology variation.

2. The system of claim 1, wherein the lane identifier information is obtained from a two-dimensional (2D) image captured by a front-facing camera of the vehicle.

3. The system of claim 2, wherein the lane identifier information includes a plurality of x-y coordinate pairs representing pixels of the 2D image that correspond to the lane identifiers.

4. The system of claim 3, wherein the controller is configured to determine the distances between the lane identifiers at the plurality of different points along the lane by determining an x-coordinate difference at a plurality of different y-coordinates of the plurality of x-y coordinate pairs.

5. The system of claim 4, wherein the controller is configured to transform the uncorrected lane topology profile from a frame of reference of the front-facing camera to the inertial frame of reference of the vehicle.

6. The system of claim 5, wherein the monitored orientation of the vehicle comprises at least one of yaw, pitch, and roll of at least one of the front-facing camera and the vehicle.

7. The system of claim 1, wherein the controller receives the image from the front-facing camera and identifies the lane identifier information from the image.

8. The system of claim 1, wherein the front-facing camera identifies and provides to the controller the lane identifier information as two polynomials or datasets defining the lane identifiers.

9. The system of claim 1, wherein the autonomous driving feature is adaptive or intelligent cruise control, and wherein the controller utilizes the corrected lane topology profile to proactively control acceleration or deceleration of the vehicle during adaptive or intelligent cruise control operation in anticipation of the upcoming road topology variation.

10. The system of claim 1, wherein the autonomous driving feature is transmission gear shift management, and wherein the controller utilizes the corrected lane topology profile to proactively control gear shifts of a transmission of the vehicle in anticipation of the upcoming road topology variation.

11. A road topology estimation and autonomous driving method for a vehicle, the method comprising:
receiving, by a controller of the vehicle and from a set of sensors of the vehicle, a monitored orientation of the vehicle;
obtaining, by the controller, lane identifier information indicative of identifiers that define a lane of a road along which the vehicle will travel;
based on the lane identifier information, determining, by the controller, distances between the lane identifiers at a plurality of different points along the lane to obtain lane width information;
using the lane width information and a known or assumed lane width, determining, by the controller, a depth or distance from the vehicle to each of the plurality of different points along the lane to obtain an uncorrected lane topology profile;
based on the monitored orientation of the vehicle, transforming, by the controller, the uncorrected lane topology profile to an inertial frame of reference of the vehicle to obtain a corrected lane topology profile; and
controlling, by the controller, an autonomous driving feature of the vehicle based on the corrected lane topology profile to proactively compensate for an upcoming road topology variation.

12. The method of claim 11, wherein the lane identifier information is obtained from a two-dimensional (2D) image captured by a front-facing camera of the vehicle.

13. The method of claim 12, wherein the lane identifier information includes a plurality of x-y coordinate pairs representing pixels of the 2D image that correspond to the lane identifiers.

14. The method of claim 13, wherein the determining of the distances between the lane identifiers at the plurality of different points along the lane comprises determining an x-coordinate difference at a plurality of different y-coordinates of the plurality of x-y coordinate pairs.

15. The method of claim 14, wherein the transforming of the uncorrected lane topology profile is from a frame of reference of the front-facing camera to the inertial frame of reference of the vehicle.

16. The method of claim 15, wherein the monitored orientation of the vehicle comprises at least one of yaw, pitch, and roll of at least one of the front-facing camera and the vehicle.

17. The method of claim 11, further comprising receiving, by the controller and from the front-facing camera, the image, and identifying, by the controller, the lane identifier information from the image.

18. The method of claim 11, wherein the front-facing camera identifies and provides to the controller the lane identifier information as two polynomials or datasets defining the lane identifiers.

19. The method of claim 11, wherein the autonomous driving feature is adaptive or intelligent cruise control, and wherein controlling the autonomous driving feature comprises utilizing the corrected lane topology profile to proactively control acceleration or deceleration of the vehicle during adaptive or intelligent cruise control operation in anticipation of the upcoming road topology variation.

20. The method of claim 11, wherein the autonomous driving feature is transmission gear shift management, and wherein controlling the autonomous driving feature comprising utilizing the corrected lane topology profile to proactively control gear shifts of a transmission of the vehicle in anticipation of the upcoming road topology variation.
